(19) United States
(12) Patent Application Publication
(10) Pub. No.: US 2018/0087167 A1
(43) Pub. Date: Mar. 29, 2018

(54) AN ASSEMBLY BODY AND ELECTRODE FOR ELECTROLYSIS

(71) Applicants: TDK CORPORATION, Tokyo (JP); RIO TINTO ALCAN INTERNATIONAL LIMITED, Montreal (CA)

(72) Inventors: Kazuhiro YOSHIDOME, Tokyo (JP); Ryoma NAKAZAWA, Tokyo (JP)

(73) Assignees: TDK CORPORATION, Tokyo (JP); RIO TINTO ALCAN INTERNATIONAL LIMITED, Montreal, QC (CA)

(21) Appl. No.: 15/577,059

(22) PCT Filed: May 26, 2015
(86) PCT No.: PCT/JP2015/002665

§ 371 Date: Nov. 27, 2017

(51) Int. Cl. C25C 3/08; B32B 9/04; B32B 15/04; B32B 15/20

(52) U.S. Cl. CPC C25C 3/08; B32B 9/041; C22C 19/03; B32B 15/20; B32B 15/043

(57) ABSTRACT

An assembly body including a cermet member, a metal member and an intermediate member bonded to the cermet member and the metal member, wherein the cermet member includes an oxide phase and a metal phase, the intermediate member includes at least a first intermediate layer and a second intermediate layer, the first intermediate layer is bonded to the cermet member, the first intermediate layer includes at least a first metal M1, the second intermediate layer includes at least a second metal M2, a melting point of the first metal M1 is lower than the second metal M2, a weight concentration of M1 at the first intermediate layer is higher than the weight concentration of M1 at the second intermediate layer, and the weight concentration of M2 at the second intermediate layer is higher than the weight concentration of M2 at the first intermediate layer.

### TECHNICAL FIELD

The present invention relates to an assembly body comprising a cermet member and a metal member made as one body, and an electrode for an electrolysis using said assembly body.

### BACKGROUND ART

Recently, a cermet member used as an electrode material under harsh environment such as a molten salt electrolysis or so, comprising a ferrite electrode material to improve corrosion resistance and a metal component to improve conductivity is widely known (Patent document 1). The cermet member is known as it can maintain high conductivity and corrosion resistance even at high temperature range for example of 900 to 1000° C. or so, thus the cermet material having good characteristics in many ways are being developed.

When using the cermet member as the electrode, the cermet member becomes a part of the electric current path. Also, the cermet member has high electric resistance compared to a metal member. Thus, the volume of the cermet member can be reduced with advantage when an assembly body of a cermet member and a metal member is used as an electrode compared to the case wherein only the cermet member is used singularly as an electrode; thereby the electric resistance of the entire electrode can be reduced. An additional benefit is the reduction of the cost of the electrode.

Therefore, a bonding technique is in demand to bond the metal member and the cermet member through which the electric current flows (Patent document 2).

However, it is difficult to obtain a sufficient bonding strength and durability when the metal member and the cermet member are bonded due to the influence of the heat strain or so. Also, when the bonded member is used as an electrode, it becomes an object to have the bonding method which secures the electric conductivity.

When bonding the cermet member and the metal member by simple heat treatment, the assembly body tends to easily crack. When the assembly body is cracked, then the mechanical strength becomes small; and when the assembly body is used as an electrode, there is a problem that the electric resistance raises compared to the case where there is no crack.

Therefore, the practical uses of the assembly body wherein the cermet member and the metal member are bonded were delayed compared to the practical use of the cermet material.

The patent document 2 discloses an assembly body used as an electrode material for aluminum production wherein the cermet member and the metal member are made as one body via an intermediate layer. Here, in said assembly body, said metal member becomes a part of the electric current path, thus the volume of the cermet member can be reduced compared to the case wherein only the cermet member is used singularly as the electrode. Further, for an electrode using said assembly body, the electric resistance can be reduced more than for an electrode using said cermet member alone, thus the electric power consumption of aluminum production or so can be reduced. Also, by substituting the carbon electrode used for the aluminum production or so by the cermet electrode or by the composite electrode, the amount of emission of CO₂ can be reduced.

Patent document 2 discloses the assembly body wherein the intermediate layer is composed of foam having many voids and forming a particular network structure. It is believed that thanks to this network structure the stress of entire assembly body is relieved, and thus no crack forms in the cermet member. However, when the intermediate layer has the network structure as in patent document 2, a continuous, reproducible electrical contact cannot be ensured at working temperature which can result in heterogeneous electric current density distribution, thus when used as the electrode for the electrolysis, the electrolysis efficiency may deteriorate.

Further, when producing the assembly body by making the cermet member and the metal member as one body via the intermediate layer, the voids were formed in the cermet member near the intermediate layer, and the bonding strength of the assembly body was significantly reduced.

### PATENT DOCUMENTS

### Citation List

### Patent Literature

PTL 1: U.S. Pat. No. 4,620,905

PTL 2: U.S. Pat. No. 7,316,577

### SUMMARY OF INVENTION

The present invention was attained in view of such situation, and its object is to provide the assembly body having only little voids in the intermediate member forming the assembly body and nearby thereof, and further the assembly body made of the metal member having sufficient bonding strength and the cermet member; and the electrode for the electrolysis using said assembly body.

In order to solve the above mentioned problem and to attain the objects, the assembly body of the present invention is an assembly body comprising a cermet member, a metal member and an intermediate member bonded to said cermet member and said metal member, wherein

said cermet member includes an oxide phase and a metal phase,

said intermediate member comprises at least a first intermediate layer and a second intermediate layer,

said first intermediate layer is bonded to said cermet member,

said first intermediate layer includes at least a first metal M1,

said second intermediate layer includes at least a second metal M2,

a melting point of said first metal M1 is lower than said second metal M2,

a weight concentration of M1 at said first intermediate layer is higher than the weight concentration of M1 at said second intermediate layer, and

the weight concentration of M2 at said second intermediate layer is higher than the weight concentration of M2 at said first intermediate layer.

By having the above constitution, the cermet member comprises fewer voids, and the assembly body with enhanced bonding strength can be obtained. The reason that the assembly body with enhanced bonding strength can be obtained due to the above mentioned constitution is because the first intermediate layer facilitates the bonding between the cermet member and the intermediate member, and also the second intermediate layer prevents the metal phase in the cermet member from moving to the metal member, thereby generation of void near the bonding part in the cermet member is suppressed.

The assembly body of the present invention may take a constitution that said first intermediate layer is also bonded to said second intermediate layer.

The assembly body according to the present invention may take a constitution that said second layer is bonded to said metal member.

In the assembly body according to the present invention, from the point of enhancing the bonding strength, the weight ratio (M1/M2) between M1 and M2 in said first intermediate layer preferably satisfies the below equation (1).

40/60≦M1/M2≦90/10 Equation (1)

In the assembly body according to the present invention, preferably M1 is Cu, and M2 is Ni.

In the present invention according to the present invention, preferably said intermediate member is substantially made of Cu and Ni.

Also, said intermediate member included in the assembly body according to the present invention may comprise a third intermediate layer in addition to said first intermediate layer and said second intermediate layer, and said third intermediate layer may be bonded to said metal member.

Since the composite further comprises said third intermediate layer which is bonded to said metal member, said third intermediate layer facilitates the bonding between said intermediate member and said metal member, and the bonding strength is enhanced.

Also, it may be an assembly body wherein the weight concentration of M1 at said third intermediate layer is higher than the weight concentration of M1 at said second intermediate layer, and the weight concentration of M2 at said third intermediate layer is lower than the weight concentration of M2 at said second intermediate layer.

Further, in the assembly body comprising said third intermediate layer, said second intermediate layer may be bonded to said first intermediate layer and said third intermediate layer.

In the assembly body according to the present invention, preferably said oxide phase included in said cermet member includes at least the oxide of Ni.

In the assembly body according to the present invention, preferably at least part of said oxide phase included in said cermet member is made of nickel ferrite.

In the assembly body according to the present invention, preferably said metal phase included in said cermet member includes at least one metal selected from Ni, and Cu.

In the assembly body according to the present invention, preferably Sₒ/Sₘ, satisfies below equation (2) when Sₒ is an area of said oxide phase at a cross section of said cermet member, Sₒ, is the area of said metal phase and Sₒ/Sₘ, is an area ratio between said oxide phase and said metal phase.

60/40≦Sₒ/Sₘ≦90/10 Equation (2)

In the assembly body according to the present invention, preferably, said oxide phase comprises a spinel ferrite phase expressed by a composition formula of NiₓFe_{y}M_{z} O₄ (x+y+z=3, x≠0, y≠0, and M is at least one selected from the group consisting of Al, Co, Cr, Mn, Ti, Zr, Sn, V, Nb, Ta, Hf), and

a nickel oxide phase expressed by the composition formula of Ni_{x′}Fe_{1-x′}O (x′≠0), and

when entire said cermet member including said oxide phase and said metal phase is 100 wt %, then

a content ratio of said spinel ferrite phase is 40 to 80 wt %,

the content ratio of said nickel oxide phase is 0 to 10 wt % (including 0 wt %), and

the content ratio of said metal phase is 15 to 45 wt %.

Preferably, an average composition of said spinel ferrite phase included in said cermet member is expressed by the composition formula of Niₓ₁Fe_{y1}M_{z1}O₄ (0.60≦x1≦0.90, 1.90≦y1≦2.40, 0.00≦z1≦0.20).

Preferably, said nickel oxide phase is included in said cermet member, and the average composition of said nickel oxide phase is expressed by Ni_{x′1}Fe_{1-x′1}O (0.70≦x′1≦1.00).

Preferably, the content ratio of Ni is 20 to 90 wt %, and the content ratio of Cu is 10 to 80 wt % at said metal phase when entire said metal phase included in said cermet member is 100 wt %.

In the assembly body according to the present invention, said metal member includes at least one of Ni, Cu, Fe.

Further, preferably said metal member includes at least Ni and Fe.

Further preferably, a content of Ni included in said metal member is 40 to 85 wt %, and the content of Fe is 15 to 60 wt % when entire said metal member is 100 wt %.

In the assembly body according to the present invention, preferably a difference in absolute value between an average linear expansion coefficient of said cermet member and the average linear expansion coefficient of said metal member being 2.0 ppm/° C. or less is present within a predetermined range of 1000° C. or higher.

Although there is no limit to the use of the assembly body according to the present invention, for example it can be used for the electrode for the electrolysis.

The electrode for electrolysis comprising the assembly body according to the present invention is an electrode for electrolysis with excellent corrosion resistance compared to conventional ones comprising the cermet member and the metal member. Further, in case the cermet member and/or the metal member includes Ni, and particularly when used for the molten salt electrolysis such as for aluminum production, then the electrode for the electrolysis will have low solubility to the molten salt (particularly of fluoride), and will have excellent durability.

A process for producing an assembly body of the present invention is a process for producing an assembly body comprising a cermet member, a metal member and an intermediate member having at least a first intermediate layer and a second intermediate layer comprising the steps of

preparing a first precursor to become the first intermediate layer after heating and a second precursor to become the second intermediate layer after heating,

making the first precursor contact with the cermet member and the second precursor arranged between the first precursor and the metal member, and

heating at a temperature where the first precursor melts but the second precursor does not melts in order to bond the cermet member and the metal member.

### BRIEF DESCRIPTION OF DRAWINGS

FIG. 1 is schematic diagram of enlarged cross section of cermet member of the assembly body according to one embodiment of the present invention.

FIG. 2 is the schematic diagram of the cross section of the assembly body according to one embodiment of the present invention.

FIG. 3 is the schematic diagram of the cross section of the assembly body according to one embodiment of the present invention.

FIG. 4 is a schematic diagram of line analysis result showing the method of determining the element concentration at each layer and a boundary between each layers.

FIG. 5 is a temperature profile at the bonding step.

FIG. 6 is a schematic diagram which explains the definition of the average linear expansion coefficient.

FIG. 7 is a schematic diagram of the example showing the relation between the temperature and the thermal expansion at the cermet member and the metal member.

FIG. 8 is the schematic diagram showing the condition of carrying out the strength measurement by bending at four points.

FIG. 9 is the schematic diagram showing the shape of the assembly body used for the strength measurement by bending at four points.

### DESCRIPTION OF EMBODIMENTS

Hereinbelow, the embodiment of the present invention will be explained by referring to the figures. The present invention is not to be limited to the context described in below.

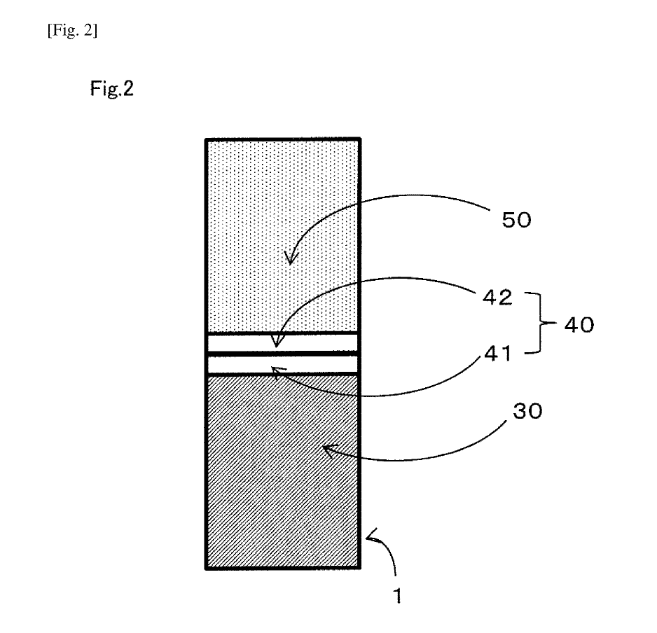

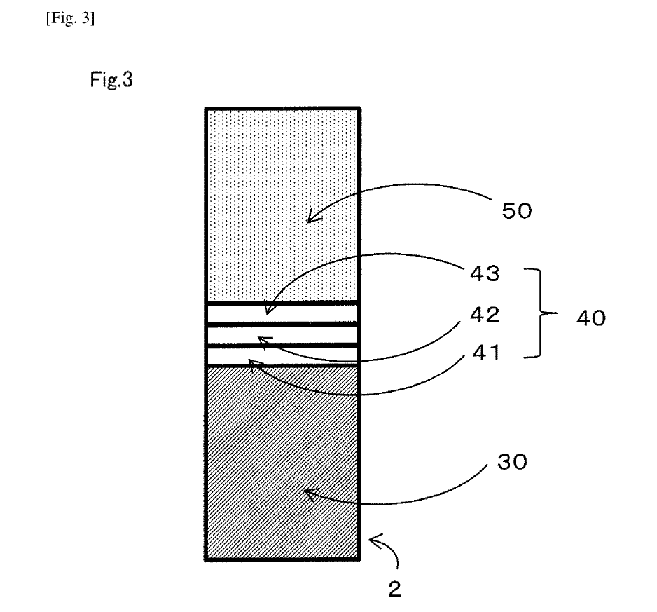

As shown in FIG. 2 and FIG. 3, the assembly body according to the present invention comprises the cermet member 30, the metal member 50, and the intermediate member 40. Said intermediate member 40 is bonded to said cermet member 30 and said metal member 50, and also comprises plurality of intermediate layers.

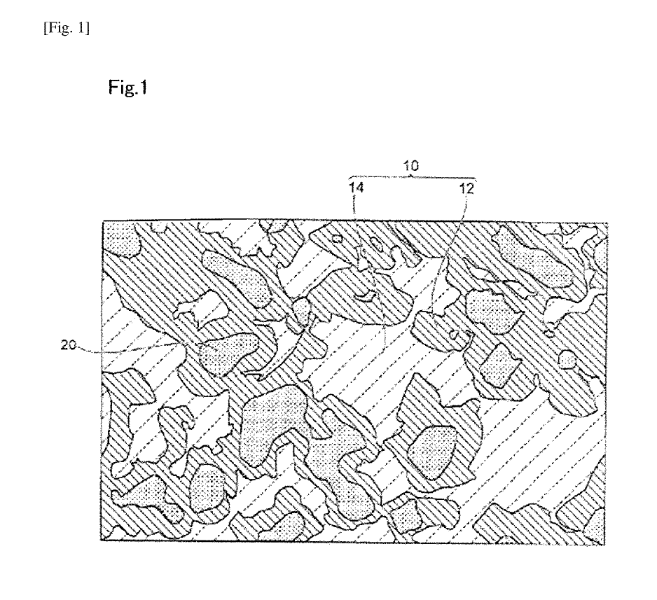

FIG. 1 is the schematic diagram showing the internal structure of the cermet member 30. The cermet member 30 according to the present invention comprises the oxide phase 10 and the metal phase 20.

The oxide phase 10 preferably comprises at least the oxide of Ni. In case the assembly body according to the present embodiment is used for the molten salt electrolysis such as refining electrolysis of aluminum or so, since the cermet member comprises Ni, the solubility against the molten salt (particularly of fluorides) can be lowered compared to the case of not comprising Ni. In other words, since the cermet member having Ni, the corrosion resistance of the cermet member at high temperature is enhanced.

Also, at least a part of the oxide phase 10 is preferably made of nickel ferrite from the point of improving the conductivity and the corrosion resistance; and further preferably the oxide phase 10 is made mainly of nickel ferrite.

“The oxide phase 10 is made mainly of nickel ferrite” means that the content ratio of the nickel ferrite is 70 wt % or more in case the entire oxide of Ni in the oxide phase 10 is 100 wt %.

When Sₒ is an area of said oxide phase 10, Sₘ, is the area of said metal phase 20, and Sₒ/Sₘ, is an area ratio between said oxide phase 10 and said metal phase 20, preferably Sₒ/Sₘ, satisfies 60/40≦Sₒ/Sₘ≦90/10. Sₒ/Sₘ is preferably within the above mentioned range, by covering the metal phase in the cermet member with the oxide phase, the metal phase can be prevented from dissolving into the fluorides and also the conductivity of the cermet member can be improved.

The metal phase 20 preferably includes at least one metal selected from Ni, and Cu; and further preferably in case the entire metal phase 20 is 100 wt %, the content ratio of Ni is 20 to 90 wt %, and the content ratio of Cu is 10 to 80 wt %. The metal phase 20 preferably has the above mentioned constitution because the corrosion resistance of the cermet member can be improved.

Note that, the area ratio between the oxide phase 10 and the metal phase 20 is calculated by observing the cut face of the cermet member 30 using the backscattered electron image (BEI) by the electron microscope at the magnification of 300 to 1000×.

Here, the oxide phase 10 can comprise the spinel ferrite phase 12 and the nickel oxide phase 14. The spinel oxide phase 12 comprises the spinel type crystal structure and comprises the spinel ferrite expressed by the composition formula of NiₓFe_{y}M_{z}O₄ (x+y+z=3, x≠0, y≠0, and M is at least one selected from the group consisting of Al, Co, Cr, Mn, Ti, Zr, Sn, V, Nb, Ta, Hf). The nickel oxide phase 14 comprises the nickel oxide expressed by the composition formula of Ni_{x′}Fe_{1-x′}O (x′≠0). Also, the oxide phase 10 preferably comprises at least the spinel ferrite phase 12.

The metal phase 20 is dispersed in the oxide phase 10, and preferably it is dispersed mainly in the spinel ferrite phase 12. In other words, preferably it forms the constitution that a lot of the metal phase 20 is trapped in the spinel ferrite phase 12. Also, since the cermet member is a sintered body, the inside of the spinel ferrite phase 12, the inside of the nickel oxide phase 14, and/or the boundary part of each phase comprises small amount of voids (not shown in the figure).

When the entire cermet member 30 is 100 wt %, preferably the content ratio of the spinel ferrite phase 12 is 40 to 80 wt %, and the content ratio of the oxide nickel phase 14 is 0 to 10 wt % (including 0 wt %), and the content ratio of the metal phase 20 is 15 to 45 wt %. The content ratio of each phase is preferably within the above mentioned range, since the dissolving of the cermet member to the molten salt during the molten salt electrolysis can be minimized, and also since it has the conductivity, the electrolytic efficiency can be improved.

The average composition of the entire spinel ferrite phase 12 included in the cermet member 30 is preferably within the range of Niₓ₁Fe_{y1}M_{z1}O₄ (0.60≦x1≦0.90, 1.90≦y1≦2.40, 0.00≦z1≦0.20). The average composition of the entire spinel ferrite phase 12 is preferably within the above mentioned range, because it is the best compromise between good electrical conductivity and good corrosion resistance.

The cermet member 30 preferably includes the nickel oxide phase 14, and more preferably the average composition of the entire nickel oxide phase 14 included in the cermet member 30 is within the range expressed by Ni_{x′1}Fe_{1-x′1}O (0.70≦x′1≦1.00). The average composition of the nickel oxide phase 14 is within the above mentioned preferable range because it results from a chemical balance with the other phases (spinel ferrite phase 12 and metal phase 20).

The type of the metal included in the metal member 50 is not particularly limited. The metal member 50 preferably includes at least one of Ni, Cu, and Fe.

Also, the metal member 50 preferably includes at least Ni and Fe. When the entire metal member 50 is 100 wt %, the content of Ni included in the metal member 50 is preferably 40 to 85 wt %, and more preferably it is 55 to 80 wt %. Also, the content of Fe included in the metal member 50 is preferably 15 to 60 wt %, and more preferably the content of Fe is 20 to 45 wt %.

Hereinafter, the intermediate layer included in the intermediate member 40 will be described.

FIG. 2 is the schematic diagram of the assembly body 1 of which the intermediate member having a two layered structure. The cermet member 30 which is made of a sintered body of the cermet material, and the metal member 50 are made into one body via the intermediate member 40. Also, the intermediate member 40 comprises layers of first intermediate layer 41 and the second intermediate layer 42 in the order closer to the cermet member 30.

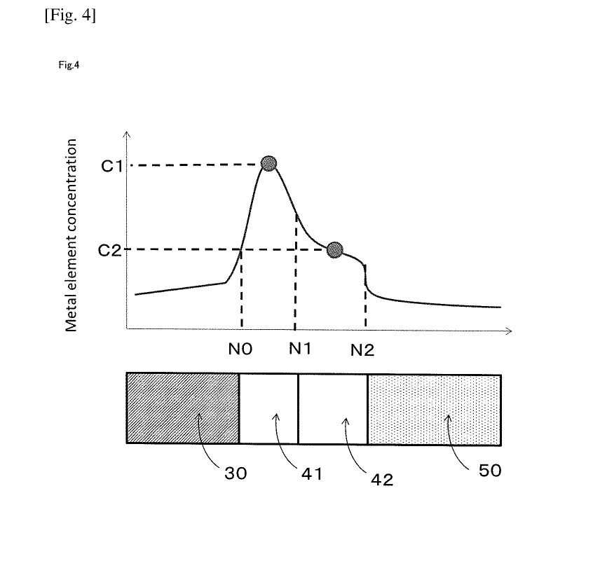

As the method of determining the boundary between the cermet member 30 and the intermediate member 40, the boundary between each intermediate layer, and the boundary between the intermediate member 40 and the metal member 50, it will be described by referring to FIG. 4. Note that, FIG. 4 uses the assembly body 1 described in FIG. 2 as an example, however the constitution of the assembly body according to the present invention is not limited to assembly body 1.

First, using EDS (Energy Dispersive Spectroscopy), the line analysis of the concentration of each metal element is carried out in the vertical direction against the bonded face between the cermet member 30 and the intermediate member 40 of the assembly body. Then, the point which is the inflection point of the concentration curve and that the absolute value of the slope of the concentration curve takes the maximum value (in FIG. 4, N0, N1 and N2) is determined as boundary. In FIG. 4, N0 is the boundary between the cermet member 30 and the first intermediate layer 41, N1 is the boundary between the first intermediate layer 41 and the second intermediate layer 42, and N2 is the boundary between the second intermediate layer 42 and the metal member 50.

The inflection point is the point where the second derivative f″(x) is 0 and the first derivative f′(x) is extremum, when the curve is expressed by the points (x, y) on the function of y=f(x).

Also, the position of the boundary can be determined with visual observation by carrying out the mapping of each element using EDS, and the position of the boundary determined by the above mentioned method using the line analysis and the position of the boundary determined by the visual observation of the mapping substantially matches.

Next, the determining method of each element concentration in each intermediate layer will be explained by referring to FIG. 4.

For the concentration of each element in the intermediate layer, if the concentration of said element has the maximum value and the minimum value in said intermediate layer, then it will be the maximum value and the minimum value. For example, the concentration of the first intermediate layer 41 of FIG. 4 is the maximum value C1. Also, if the concentration of said element does not have the maximum value or the minimum value in said intermediate layer, it will be the concentration of said element at the middle point of two boundaries. For example, the concentration of second intermediate layer 42 of FIG. 4 is the concentration C2 which is the middle point (not shown in the figure) between the boundary of N1 of the first intermediate layer 41 and the second intermediate layer 42, and the boundary N2 of the second intermediate layer 42 and the metal member 50.

Here, the intermediate member 40 comprises at least two metal elements of M1 and M2. The type of M1 and M2 are not particularly limited except that the melting point of M2 is higher than that of M1. Further, the intermediate layer 41 at least comprises M1, and the intermediate layer 42 at least comprises M2. Further, the concentration of M1 is higher at the first intermediate layer 41 than at the second intermediate layer 42, and the concentration of M2 is higher at the second intermediate layer 42 than at the first intermediate layer 41.

FIG. 3 is the schematic diagram of the assembly body 2 of which the intermediate member has the three layer structure. The assembly body 2 shown in FIG. 3 has the third intermediate layer 43 between the second intermediate layer 42 and the metal member 50, and it is the same as the assembly body 1 except that it is bonded to the intermediate layer 42 and the metal member 50.

The method of determining the concentration or the boundary of each element in the third intermediate layer 43 is the same as the method of determining the concentration or the boundary of each element in first intermediate layer 41 and second intermediate layer 42 discussed in above.

The third intermediate layer 43 may be constituted mainly by M1 and/or M2 as same as the first intermediate layer 41 and the second intermediate layer 42, and it may also be constituted mainly by solder; however it is not limited thereto.

As similar to the first intermediate layers 41 and the second intermediate layer 42, when M1 and/or M2 are included in the third intermediate layer 43, the weight concentration of M1 at the third intermediate layer 43 is higher than the weight concentration of M1 at the second intermediate layer 42; and the weight concentration of M2 at the third intermediate layer 43 is lower than the weight concentration of M2 at the second intermediate layer 42.

The intermediate layer included in the intermediate member 40 is not limited to two or three as shown in FIG. 2 and FIG. 3, and it may be 4 or more. Also, the lower limit of the thickness per one intermediate layer is 10 μm. Further, the thickness per one intermediate layer is preferably 20 to 2000 μm, and the thickness of entire intermediate member 40 is preferably 20 to 3000 μm.

In the assembly body according to the present embodiment, it is preferable to use Cu as M1, Ni as M2, and it is further preferable that metal element included in the intermediate member according to the present embodiment is consisted substantially of Cu and Ni. “consisted substantially of Cu and Ni” means that the content ratio of Cu and Ni at the intermediate member is 80 wt % or more in case the entire metal element included in the intermediate member is 100 wt %. Also, the above mentioned constitution is preferable since the bonding strength between the cermet member and the metal member can be improved.

### The Production Method of the Assembly Body

Next, the suitable production method of the assembly body according to the present embodiment will be described, however the production method of the assembly body according to the present invention is not limited to the below described method.

The production method of the cermet member constituting the assembly body of the present embodiment comprises, a mixing step of obtaining the mixed powder by mixing the ferrite oxide powder and the metal powder, a molding step of obtaining the molded body by molding the mixed powder, and a firing step of obtaining the fired body by firing the molded body under predetermined atmosphere and temperature.

For the mixing step, the ferrite source material powder comprising iron oxide (for example Fe₂O₃) and metal oxide (for example NiO) in a desired mol ratio is prepared. Then, said ferrite source material powder is calcined and pulverized to obtain the ferrite oxide powder.

In case of using the assembly body according to the present embodiment to the molten salt electrolysis such as in aluminum production or so, since the cermet member which is obtained at the end comprises Ni, the solubility against the molten salt (particularly of fluorides) can be lowered compared to the case of not comprising Ni.

Also, the metal powder is prepared separately from said ferrite oxide powder. The type of said metal powder is not particularly limited, and it may be a powder of single metal such as powder of Ni metal alone or the powder of Cu metal alone, it may be metal powder of two or more types for example metal powder mixing the metal powder of Ni and metal powder of Cu in a specific weight ratio. Further, two or more metal powders may be melted to form alloy powder, and this may be used as the metal powder as well.

The metal powder preferably comprises Ni. In case of using the assembly body according to the present embodiment to the molten salt electrolysis such as in aluminum production or so, by having Ni in the cermet member which is obtained at the end, the solubility against the molten salt (particularly of fluorides) can be lowered compared to the case of not comprising Ni.

Then, said ferrite oxide powder and said metal powder are mixed to obtain the mixed powder. The method of mixing said ferrite oxide powder and said metal powder is not particularly limited, and the usual mixing method such as by ball mill or so can be used. Also, the mixing method may be dry mixing method or wet mixing method, and it only needs to be a method which can uniformly mix said ferrite oxide powder and said metal powder.

The average primary particle diameter of the mixed powder obtained by the mixing step is not particularly limited as well, however usually average primary particle diameter of the mixed powder having 1 to 30 μm is obtained.

In the molding step, said mixed powder is molded to produce the molded body. The molding method is not particularly limited, and for example the molded body can be produced by the usual dry molding method which is used in general. In case of carrying out the usual dry molding, said mixed powder added with a binder is filled into the usual mold, and press molded to produce the molded body. The type of the binder is not particularly limited, and the binder used for the usual molding can be used. From the point that a good molding property can be obtained, polyvinylalcohol (PVA) is preferably used as the binder.

Note that, the molding method is not limited to the dry molding method, and it may be a wet molding wherein the slurry including the mixed powder and the solvent is pressure molded while removing the solvent, further it may be other molding method.

The firing step can be carried out under the atmosphere of active gas; however it is preferable to carry out under the atmosphere of the inactive gas such as nitrogen gas or argon gas or so. By firing the molded body under the inactive gas atmosphere, the oxidation of the metal powder can be prevented, and also nickel oxide is reduced and releases Ni which facilitates to form the metal alloy between the metal powder and the released Ni. Thus, due to the alloy between the metal powder and the Ni, the conductivity of the cermet member is prevented from lowering.

The firing temperature and the firing time during the firing step are not particularly limited, and it can be appropriately regulated by said ferrite oxide powder and said metal powder which is used as the source material. For example, the sintered body can be obtained by raising the temperature under the atmosphere of nitrogen gas or argon gas, and firing at the firing temperature of 1200 to 1400° C., more preferably of 1300 to 1400° C. for preferably 1 to 10 hours and more preferably 2 to 6 hours. By setting the firing temperature within the above mentioned range, the amount of the nickel oxide phase in the oxide phase of the cermet member can be made small, thus the conductivity of the cermet member tends to improve.

Also, in case of considering the heat resistance of the firing facilities and the production costs, the firing temperature is preferably 1400° C. or less.

Further, the temperature increasing speed during the firing step is preferably 30 to 500° C./hour, and more preferably 50 to 350° C./hour. By making the temperature increasing speed to 500° C./hour or lower, the density of the cermet member can be lowered. Also, by making the temperature increasing speed to 30° C./hour or more, the production cost of the cermet member can be reduced.

Also, for the temperature decreasing speed during the firing step, it is preferably 10 to 500° C./hour, and more preferably 30 to 350° C./hour. By making the temperature decreasing speed to 500° C./hour or lower, the density of the cermet member can be lowered. Also, by making the temperature decreasing speed to 10° C./hour or more, the production cost of the cermet member can be reduced.

The sintered body obtained by the firing step may be used as the cermet member without any processing, or it may be used as cermet member having desired shape by carrying some degree of processing.

For the metal member, the metal being used is not particularly limited. For example, those used for the structure such as stainless steel or so may be selected. In case the assembly body according to the present embodiment is used for the molten salt electrolysis for aluminum production or so, it is preferable to select the Ni based alloy such as Ni—Fe alloy or so as the material of the metal member, since the heat resistance and the oxidation resistance are high and the solubility to the molten salt (particularly of fluoride) is low. Also, a metal member containing iron is preferred as the cermet member loses iron during electrolysis and can be refilled by the iron contained in the metal member. The presence of Ni in the intermediate layer can advantageously allow a regulation of the iron migration from the metal member toward the cermet member. Also, commercially available pure Ni, the alloy including Ni and Cu, and the alloy including Ni, Cr and Fe or so can be selected as well.

The assembly body according to the present embodiment can be obtained by making the cermet member and the metal member obtained by the below steps into one body. The method of making into one body is not particularly limited, and for example the method of inserting the plurality of precursors between the cermet member and the metal member and applying the pressure while heating is preferably used. Hereinafter, the step of making the cermet member and the metal member as one body will be referred as a bonding step. Also, plurality of precursors will be referred as the first precursor and the second precursor towards the metal member from the cermet member. The first precursor includes at least first metal M1, and the second precursor includes at least the second metal M2.

The type of said first metal M1 and said second metal M2 is not particularly limited, however it is necessary that the melting point of M1 is lower than that of M2. Further, the heating temperature during the bonding step is preferably higher than the melting point of M1 and lower than the melting point of M2. By heating at the temperature higher than the melting point of M1, the first precursor melts, thus the liquid phase diffusion bonding can be done against the cermet member and the second precursor, thus the bonding strength can be enhanced compared to the case where the first precursor contacting with the cermet member does not melt. Also, by melting at the temperature lower than the melting point of M2, the second precursor does not melt, thus the reaction can be suppressed so that the metal in the cermet member does not pass through the first precursor 1 and the second precursor and diffuses to the metal member. In order to melt only the first precursor, the M1 concentration of the first precursor is higher than the M1 concentration of the second precursor, and the M2 concentration of the second precursor is higher than the M2 concentration of the first precursor.

By making the M1 concentration of the first precursor higher than the M1 concentration of the second precursor, the M1 concentration of first intermediate layer 41 in the assembly body according to the present embodiment is higher than the M1 concentration of the second intermediate layer 42. Also, by having the M2 concentration of the second precursor higher than the M2 concentration of the first precursor, the M2 concentration of the second intermediate layer 42 is higher than the M2 concentration of the first intermediate layer 41.

Hypothetically, if the second precursor does not exist and the first precursor only exists, then all of the precursor will melt. Therefore, the metal phase 20 in the cermet member 30 diffuses to the metal member 50 and the part where the metal phase 20 was originally in the cermet member forms a void. Therefore, the void increases near the boundary between the cermet member 30 and the intermediate member 40, and the cracking easily occurs. However, in the present embodiment, since there is the second precursor which does not melt by heating, the metal phase 20 in the cermet member 30 is blocked by the second precursor and it hardly diffuses to the metal member 50. Thereby, the increase of void near the boundary between the cermet member 30 and the intermediate member 40, and the cracking can be prevented.

As discussed in the above, due to the constitution using plurality of precursors of above mentioned, the void near the boundary between the cermet member 30 and the intermediate member 40 does not occur and the bonding strength improves.

Note that, in the present embodiment, preferably the first metal M1 is Cu (the melting point of 1083° C.) and the second metal M2 is Ni (the melting point of 1455° C.).

Further, the metal member 50 is preferably the alloy including Ni. By the metal member 50 having Ni, Ni and Cu component in the intermediate member 40, particularly of the Ni and Cu component which is in contact with the second intermediate layer 42 diffuses to the metal member 50 hence the bonding strength increases.

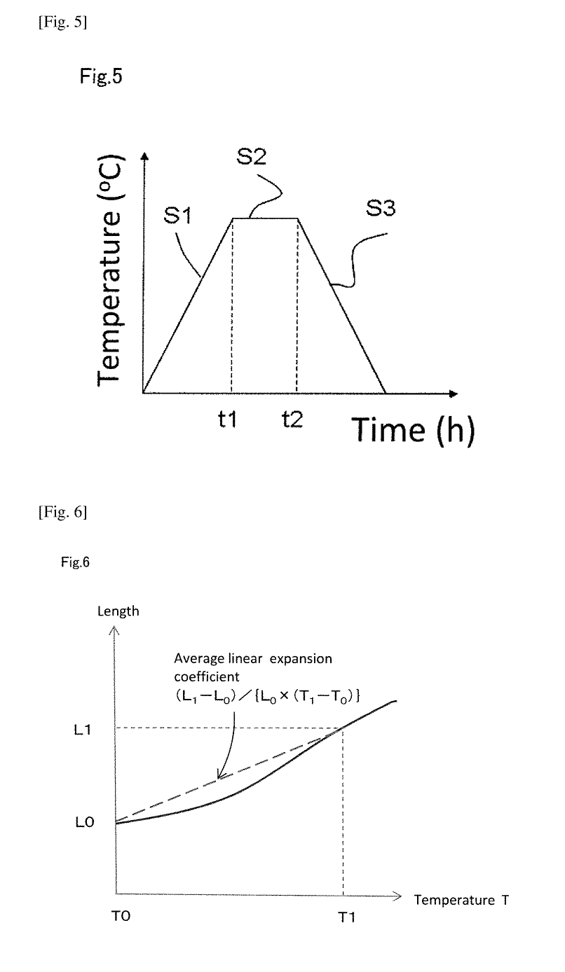

FIG. 5 is the schematic diagram showing the time difference of the temperature in time during the bonding step according to the present embodiment. As shown in FIG. 5, the bonding step includes the temperature increasing step (step S1), the high temperature maintaining step (step S2), and the temperature decreasing step (step S3). The bonding step is preferably carried out in vacuumed condition, or inactive gas atmosphere, for example Ar and N₂ or so. However, it is not limited thereto.

The temperature increasing step (step S1) is a step of gradually heating while applying a pressure to each member in the heating furnace. The temperature increasing speed is preferably 10° C./hour to 600° C./hour, and more preferably 50° C./hour to 300° C./hour. By making the temperature increasing speed to 600° C./hour or less, the cermet member and the intermediate member, and the intermediate member and the metal member are sufficiently bonded easily. Also, by making the temperature increasing speed to 10° C./hour or more, the production cost of the assembly body can be reduced.

The high temperature maintaining step (step S2) is the step which maintains at the predetermined temperature, and it starts from time t1 of FIG. 5. In the present embodiment, it is preferable to select the temperature where the first precursor (M1) melts but the second precursor (M2) does not melt. More preferably, it is carried out at the temperature where the linear expansion coefficient difference in the absolute value between the metal member and the cermet member is 2.0 ppm/° C. or less, and further preferably at the temperature where the average linear expansion coefficient of the metal member and the cermet member matches.

Here, the average linear expansion coefficient will be explained by referring to FIG. 6. Note that, in FIG. 6, T₀ is the room temperature and L₀ is the length of the sample at the room temperature T₀.

By changing the temperature (T) of the sample from T₀ to T₁ (T₀<T₁), when the length (L) of the sample are changed from L₀ to L₁, the value wherein the amount of change in the length (L₁-L₀) divided by L₀ is the thermal expansion between the temperature T₁ and the temperature T₀. Further, the value which is obtained by dividing this thermal expansion by the temperature difference (T₁-T₀) is the average linear expansion coefficient.

That is, in the present application, the average linear expansion coefficient α (T₁) between the temperature T₀ and the temperature T₁ is as shown in the below equation (A). Note that, the average linear expansion coefficient α (T₁) between the temperature T₀ and the temperature T₁ taking T₀ as the standard temperature may be referred simply as the average linear expansion coefficient at the temperature T₁.

α(T₁)=(L₁-L₀)/{L₀×(T₁−T₀)} (A)

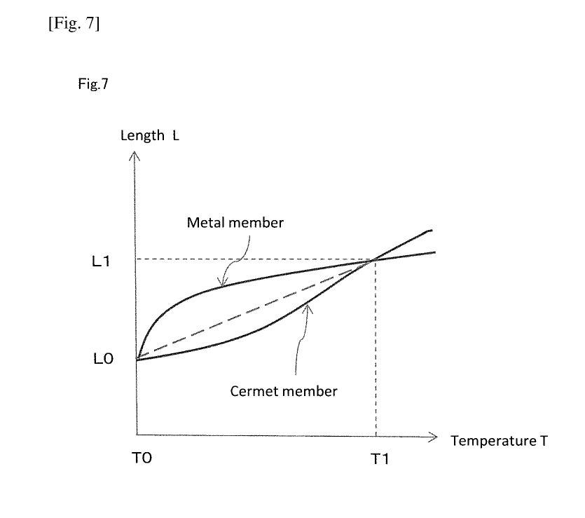

FIG. 7 shows the change of the length of the cermet member and the change of the length of the metal member when the length of the member at the standard temperature T₀ is the same. At the temperature T₁, the average linear expansion coefficient of the cermet member and the average linear expansion coefficient of the metal member are matched, and the length of the cermet member and the length of the metal member are matched. That is, in the temperature T₁, the difference between the average linear expansion coefficient of the cermet member and the average linear expansion coefficient of the metal member is 0.

When the difference between the average linear expansion coefficient at the temperature T₁ is small (the difference in the absolute value is 2.0 ppm/° C. or less), and when the high temperature maintaining is carried out at the temperature T₁, the thermal strain is small when it is returned to room temperature after the high temperature maintaining, thus a bonded body without the crack can be easily obtained. Note that, the first precursor is preferably melted by heating, thus T₁ is preferably 1000° C. or higher. At the same time, the second precursor is preferably not melted by heating, thus T₁ is preferably 1400° C. or less. Note that, in the technical field of the present invention, the standard temperature T₀ is generally 25° C. which is around the room temperature.

Note that, the temperature maintaining during the high temperature maintaining step is preferably 1100 to 1400° C., and more preferably 1100 to 1250° C. Also, the maintaining time is preferably 1 to 10 hours, and more preferably 2 to 6 hours. By setting the maintaining temperature to the above mentioned range, the cermet member, the intermediate member and the metal member forms a sufficient bonding, and the bonding strength of the assembly body improves. Further, in said cermet member, the generation of NiO is controlled to be low, thus the conductivity can be maintained high as well.

Note that, from the point of the heat resistance of the firing facilities, and the reduction of the production cost, the upper limit of the maintaining temperature is preferably 1400° C.

The temperature decreasing step (step S3) is a step of gradually cooling the assembly body in the heating furnace. The temperature decreasing speed is 10° C./hour to 600° C./hour, and more preferably 10° C./hour to 300° C./hour. By setting the temperature decreasing speed to the above mentioned range, the stress caused by the heat expansion difference at the high temperature can be relieved, thus the cracks can be reduced.

In the present embodiment, from the point of improving the bonding strength, when the total weight of Ni and Cu of the first intermediate layer 41 in the assembly body which is obtained at the end is 100, the amount of Ni is 10 to 60, and the amount of Cu is 90 to 40; and when the total weight of Ni and Cu in the second intermediate layer 42 is 100, the amount of Ni is 100 to 70 and the amount of Cu is 0 to 30.

Further, the third intermediate layer 43 constituted by the alloy having the alloy as the main component is preferably present between the second intermediate layer 42 and the metal member. The forming method of the third intermediate layer 43 is not particularly limited, and for example it can be formed by increasing the number of the precursor in the embodiment discussed in above to 3 layers. Here, the precursor which is the closest to the metal member is the third precursor.

The third precursor preferably includes at least the first metal M1. Also, preferably, the M1 concentration of the third precursor is higher than the M1 concentration of the second precursor; and the M2 concentration of the second precursor is higher than the M2 concentration of the third precursor.

Due to the above constitution, and by heating at the temperature higher than the melting point of M1 and lower than the melting point of M2, the third precursor melts, and the liquid phase diffusion bonding of the second precursor and the metal member is carried out.

In the embodiment using two layers of the first precursor and the second precursor, the second precursor which is in contact with the metal member 50 does not melt, thus the bonding between the metal member and the precursor will be a solid phase diffusion bonding. On the contrary, in the embodiment using three layers of the first precursor, the second precursor, and the third precursor, the bonding between the metal member 50 and the third precursor will be the liquid phase diffusion bonding. That is, when melting the first precursor, the third precursor is also melted thus can undergo the liquid phase diffusion bonding, and also shows good liquid phase diffusion bonding reaction against the second precursor and the metal member 50; thus the bonding strength is improved.

Therefore, in case the third precursor is used, in the assembly body obtained at end, it is possible to reduce the void formed between the second intermediate layer 42 and the metal member 50. By reducing the void, in case of using the assembly body according to the present invention as the electrode for the electrolysis, it exhibits the effect that a highly uniform electric current density distribution can be obtained.

As the embodiment wherein the third intermediate layer 43 is provided using the third precursor, in the assembly body obtained at the end, when the total amount of Ni and Cu in the first intermediate layer 41 and/or the third intermediate layer 42 is 100, then preferably the content of Ni in said intermediate layer is 10 to 60, and the amount of Cu is 90 to 40.

As discussed in the above, in the present embodiment, as the intermediate layer has the layered structure, the strength reduction due to the formation of the void of the metal phase in the cermet member can be suppressed, and the bonding strength improves since the cermet member and the first intermediate layer 41 are in good diffused condition.

The preferable embodiment of the present invention was discussed in above; however it is not to be limited thereto. For example, by using the solder as the third precursor, it can be the embodiment wherein the soldering is carried out between the second intermediate layer 42 and the metal member 50.

Note that, the metal member of the present invention may comprise 50 wt % or less of substance other than metal. The type of the substance other than the metal is not particularly limited, and for example carbon, metal oxide, metal nitride or so can be mentioned.

Hereinabove, the production method in regards with the preferable embodiment of the present invention has been described. The cermet member 30 may include the spinel ferrite phase 12, the nickel oxide phase 14 and other phases which is different from the metal phase 20; and as for the intermediate member 40 placed between the metal member 50 and the cermet member 30, the metal oxides included in the spinel ferrite phase 12 and the nickel oxide phase 14 may be included. Also, the material of the metal member 50 is not particularly limited. In the present embodiment, the metal member 50 was a Ni based alloy, however the alloy having the equal average linear expansion coefficient as the Ni based alloy may be selected as well. Also, from the point of increasing the bonding strength, the diffusion bonding method using the mechanical pressure may be used.

### EXAMPLES

The context of the present invention will be explained into further detail by referring to the examples and the comparative examples, however the present invention is not to be limited thereto.

### Example 1

The commercially available nickel oxide (NiO) powder and iron oxide (Fe₂O₃) powder were blended so that the mol ratio of NiO against Fe₂O₃ is 50/50, then it was mixed using the ball mill thereby the mixed powder was obtained. This calcination was carried out to the mixed powder by maintain at the temperature of 1000° C. for 3 hours. The obtained calcined powder was pulverized in the ball mill, thereby the ferrite oxide powder having the average primary particle diameter of 1 μm was prepared.

The obtained ferrite oxide powder and the copper (Cu) powder were blended so that the weight ratio of the ferrite oxide powder against the copper powder is 80/20. The blended powder was mixed in the ball mill, and 0.8 wt % of PVA (polyvinylalcohol) as the binder was added with respect to the total weight of the above mentioned ferrite oxide powder and the copper powder; then by mixing by the ball mill, the mixed powder was prepared.

The obtained mixed powder is press molded, thereby plurality of molded body having a rectangular parallelepiped shape were obtained. These molded bodies were fired by maintaining under N₂ atmosphere at the temperature of 1300° C. for 3 hours. Then it was gradually cooled in N₂ atmosphere, thereby plurality of the sintered body (the cermet member) having the rectangular parallelepiped shape of 1.5 cm×1.5 cm×2.0 cm were prepared.

One of the obtained cermet member was cut, and the cut face was observed by the backscattered electron image (BEI) using electron microscope (S-2100 made by Hitachi High-Technologies) for 30 random visual fields at 500× magnification, thereby the area ratio between the oxide phase and the metal phase of calculated.

As the metal member bonding with said cermet member, Ni/Cu=70/30 (wt %/wt %) rod processed into 1.5 cm×1.5 cm×2.0 cm was prepared.

The mirror face polishing was carried out to one of the face of 1.5 cm×1.5 cm of the cermet member and the one of the face of 1.5 cm×1.5 cm of the metal member.

Next, as the first precursor, the Cu foil having the thickness of 0.2 mm was prepared, and as the second precursor, the Ni foil having the thickness of 0.2 mm was prepared. Then, the face carried out with the mirror polishing of said cermet member and one face of said first precursor was contacted, and other face of said first precursor and one face of said second precursor was contacted, further other face of said second precursor and the mirror polished face of said metal member was contacted, then each member was stacked.

Then, the heat treatment was carried out while applying the load of 0.5 kPa towards the cermet member side from the metal member side. Said heat treat member was carried out in the vacuumed atmosphere, and the temperature increasing step was carried out at 300° C./hour; then the high temperature maintaining step was carried out at 1200° C. for 3 hours, then the temperature decreasing step was carried out at 300° C./hour.

Next, to the assembly body obtained, the evaluation was carried out in the below steps. First, one of the composite bodies was cut at the plane face perpendicular to the face carried out with the mirror polishing of the cermet member, then the cut face was observed, thereby it was confirmed that the assembly body has the layered structure.

Next, the mapping of each element was carried out to said cut face using EDS, thereby determined the boundary between the cermet member and the intermediate member, the boundary between the intermediate member and the metal member, and the boundary between each intermediate layers. Also, the line analysis was carried out in the vertical direction against the bonding face for each element, thereby it was confirmed that the position of boundary determined by the mapping and the point where the absolute value of the slope of the concentration curve becomes maximum which is the inflection point of the concentration curve by the line analysis matches. Note that, the mapping by EDS and the line analysis was carried out by energy dispersive X-ray analyzer (JED2110 made by JEOL).

Next, the area ratio of the void at said cut face was observed using the electron microscope. Hereinafter, the length of the part which is parallel to each layer in said cut face and the boundary between each member will be referred as “the width”.

First, the presence of the void in the cermet member was evaluated. To the part 1 mm or more away from the boundary between said cermet member and intermediate member (the first intermediate layer 41), the measurement range having the width of 1 cm was set. Then, within said measurement range, the observation of backscattered electron beam image (BEI) by electron microscope was carried out at 100× magnification. In said measurement range, the area ratio of the part where the black contrast appears, that is of the void, was calculated. Further, to the part which is within 100 μm from said boundary, the measurement range having 100 μm×width of 1 cm was set, and the area ratio of the void within said measurement range was calculated.

When the area ratio of the void of the part which is within 100 μm from said boundary was 1.2 times or more with respect to the area ratio of the void at the part 1 mm or more away from the boundary, it was determined that the void is present in the cermet member.

Next, the presence of void in each intermediate layer was evaluated. The measurement range having the width of 1 cm was set in each intermediate layer, and then the observation of backscattered electron beam image (BEI) by electron microscope was carried out at 100× magnification. In case the area ratio of the part appearing in black contrast, that is the void, was 5% or less, it was determined as no presence of the void in said intermediate layer.

For the bonding strength, after 10 obtained composite bodies were processed into rectangular parallelepiped shape, each of them was carried out with the four points bending strength test and the average value of the bonding strength was calculated.

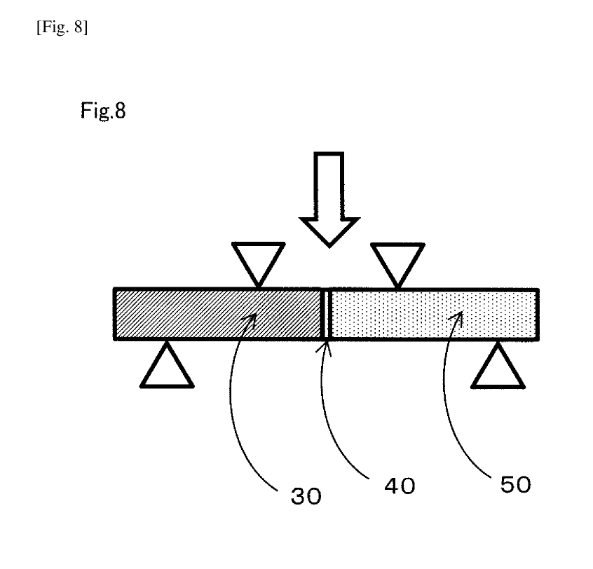

The four points bending strength test was carried out by the method shown in the schematic diagram of FIG. 8. Note that, as the four points bending strength test machine, Model 1311-D made by AIKOH ENGINEERING CO., LTD was used. In the present examples, the bonding strength of 50 MPa or more was defined as good bonding strength.

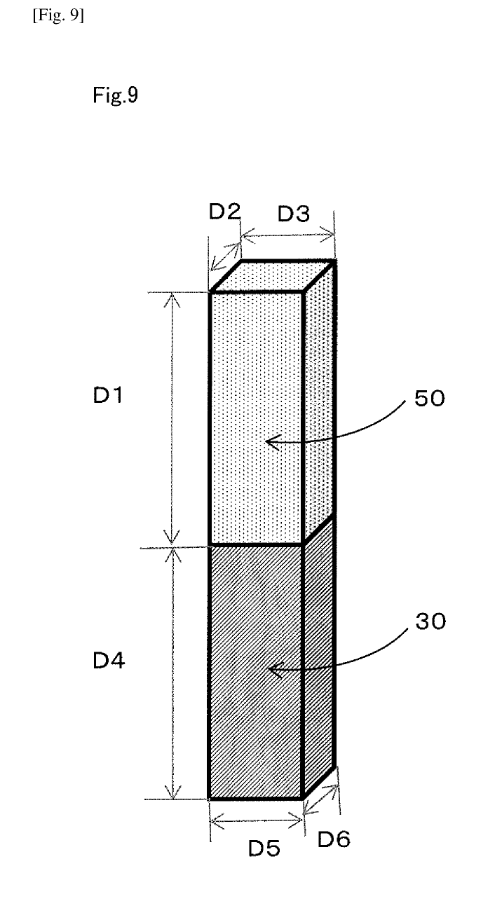

The shape of the assembly body used for the four points bending machine is rectangular parallelepiped shape as shown in FIG. 9, and D1=D4=2.0 cm, D2=D6=0.3 cm, D3=D5=0.4 cm. Note that, in FIG. 9, the intermediate member 40 is not shown.

### Comparative Examples 1 and 2

For the comparative example 1, the assembly body 1 was made as same as the example 1 except that the second precursor was omitted. For the comparative example 2, the first precursor and the second precursor was exchanged from the example 1, and Ni foil was used as the first precursor and Cu foil was used as the second precursor. Other than that, the assembly body was produced as same as the example 1. The results of example 1 and the comparative examples 1 and 2 are shown in Table 1.

When the example 1 and the comparative example 1 are compared, in the example 1, there is no void formed near the boundary in the cermet member and in each intermediate layer, and a good bonding strength was obtained. On the contrary, in the comparative example 1, the void was generated near the boundary in the cermet member and in the intermediate layer, and good bonding strength could not be obtained. In the comparative example 2, the first precursor (Ni foil) contacting with the cermet member did not melt, and the cermet member and the first precursor were unable to bond.

TABLE 1

| | | Intermediate member | | | | | | | | 4 points |
|---|---|---|---|---|---|---|---|---|---|---|
| | Cermet member | First intermediate layer | | Second intermediate layer | | Metal member | | Voids in | Voids in | bending |
| | (So + Sm = 100) | (Ni + Cu = 100 wt %) | | (Ni + Cu = 100 wt %) | | (Ni + Cu = 100 wt %) | | cermet | intermediate | strength |
| | So/Sm | Ni(wt %) | Cu(wt %) | Ni(wt %) | Cu(wt %) | Ni(wt %) | Cu(wt %) | member | layer | (MPa) |
| Example 1 | 83/17 | 40 | 60 | 100 | 0 | 70 | 30 | None | None | 115 |
| Comparative | 83/17 | 40 | 60 | No second intermediate | | 70 | 30 | Present | Present | 20 |
| example 1 | | | | layer | | | | | | |
| Comparative | 83/17 | 100 | 0 | 40 | 60 | 70 | 30 | Present | None | did not |
| example 2 | | | | | | | | | | bond |

### Examples 11 to 13, Comparative Example 3

The composite bodies of the examples 11 to 13 were formed as similar to the example 1 except that the area ratio between the oxide phase and the metal phase in the cermet member was changed by changing the source material composition of the cermet member. Then, the evaluation was carried out. Also the assembly body of the comparative example 3 was formed as same as the comparative example 1 except that the area ratio between the oxide phase and the metal phase was changed by changing the source material composition of the cermet member. Then, the evaluation was carried out. The results are shown in Table 2.

According to Table 2, in the examples 11 to 13, even when the area ratio between the oxide phase and the metal phase in the cermet member was changed, there was no void formed near the boundary in the cermet member and in each intermediate layer, and a good bonding strength was obtained as similar to that of the example 1. On the contrary, in the comparative example 3, the void is generated near the boundary in the cermet member and in the intermediate layer, and good bonding strength could not be obtained as similar to the comparative example 1.

TABLE 2

| | | Intermediate member | | | | | | | | 4 points |
|---|---|---|---|---|---|---|---|---|---|---|
| | Cermet member | First Intermediate layer | | Second intermediate layer | | Metal member | | Voids in | Voids in | bending |
| | (So + Sm = 100) | (Ni + Cu = 100 wt %) | | (Ni + Cu = 100 wt %) | | (Ni + Cu = 100 wt %) | | cermet | intermediate | strength |
| | So/Sm | Ni(wt %) | Cu(wt %) | Ni(wt %) | Cu(wt %) | Ni(wt %) | Cu(wt %) | member | layer | (MPa) |
| Comparative | 96/4 | 41 | 59 | No second intermediate | | 70 | 30 | None | Present | 10 |
| example 3 | | | | layer | | | | | | |
| Comparative | 83/17 | 40 | 60 | No second intermediate | | 70 | 30 | Present | Present | 20 |
| example 1 | | | | layer | | | | | | |
| Example 11 | 90/10 | 41 | 59 | 100 | 0 | 70 | 30 | None | None | 70 |
| Example 1 | 83/17 | 40 | 60 | 100 | 0 | 70 | 30 | None | None | 115 |
| Example 12 | 71/29 | 38 | 62 | 100 | 0 | 70 | 30 | None | None | 102 |
| Example 13 | 60/40 | 40 | 60 | 100 | 0 | 70 | 30 | None | None | 65 |

### Examples 21 to 26

The composite bodies of the examples 21 to 26 were formed as similar to the example 1 except that the composition of the first intermediate layer 41 was changed by changing the maintaining temperature during the high temperature maintaining step, then the evaluation was carried out. The results are shown in Table 3.

In the examples 21 to 26, there was no void formed near the boundary in the cermet member and in each intermediate layer, and a good bonding strength was obtained as similar to that of the example 1. However, in the examples 24 to 26 wherein the Cu concentration in the first intermediate layer 41 is lower than that of the example 1, the four points bending strength has lowered compared to the example 1. Also, according to the examples 24 to 26, it was observed that the lower the Cu concentration in the first intermediate layer 41 is, the more the bonding strength tends to decline.

If the first precursor is the same as the Cu foil, the lower the Cu concentration in the first intermediate layer 41 is, it is thought that Ni in the oxide phase near the boundary in the cermet member is diffused to the first intermediate layer 41. Further, by reducing Ni near the boundary in the cermet member, the composition near the boundary changes, thus the average liner expansion coefficient of the cermet member changes. Thus, in the examples 24 to 26, the remaining stresses of the assembly body become larger than that of the example 1, hence the four points bending strength is thought to be lowered.

TABLE 3

| | | Intermediate member | | | | | |
|---|---|---|---|---|---|---|---|
| | Cermet member | First intermediate layer | | Second Intermediate layer | | Metal member | |
| | (So + Sm = 100) | (Ni + Cu = 100 wt %) | | (Ni + Cu = 100 wt %) | | (Ni + Cu = 100 wt %) | |
| | So/Sm | Ni(wt %) | Cu(wt %) | Ni(wt %) | Cu(wt %) | Ni(wt %) | Cu(wt %) |
| Example 21 | 83/17 | 0 | 100 | 100 | 0 | 70 | 30 |
| Example 22 | 83/17 | 10 | 90 | 100 | 0 | 70 | 30 |
| Example 23 | 83/17 | 25 | 75 | 100 | 0 | 70 | 30 |
| Example 1 | 83/17 | 40 | 60 | 100 | 0 | 70 | 30 |
| Example 24 | 83/17 | 52 | 48 | 100 | 0 | 70 | 30 |
| Example 25 | 83/17 | 58 | 42 | 100 | 0 | 70 | 30 |
| Example 26 | 83/17 | 70 | 30 | 100 | 0 | 70 | 30 |

| | Temperature | | | |
|---|---|---|---|---|
| | of high | | | 4 points |
| | temperature | Voids in | Voids in | bending |
| | maintaining | cermet | intermediate | strength |
| | step (° C.) | member | layer | (MPa) |
| Example 21 | 1085 | None | None | 53 |
| Example 22 | 1125 | None | None | 70 |
| Example 23 | 1150 | None | None | 115 |
| Example 1 | 1200 | None | None | 115 |
| Example 24 | 1250 | None | None | 83 |
| Example 25 | 1300 | None | None | 56 |
| Example 26 | 1375 | None | None | 52 |

### Examples 31 to 33, 41 to 45

The composite bodies of the examples 31 to 33 were formed as similar to the example 1 except that the metal foil used for the first precursor was changed and the maintaining temperature during the high temperature maintaining step was changed. Also, the composite bodies of the examples 41 to 45 were formed as similar to the example 1 except that the metal foil used for the second precursor was changed.

For the examples 31 to 33 and 41 to 45, there was no void formed near the boundary in the cermet member and in each intermediate layer, and a good bonding strength was obtained.

TABLE 4

| | | Intermediate member | | | | | | | |
|---|---|---|---|---|---|---|---|---|---|
| | Cermet member | First precursor 1 | | First intermediate layer | | Second precursor | | Second intermediate layer | |
| | (So + Sm = 100) | (Ni + Cu = 100 wt %) | | (Ni + Cu = 100 wt %) | | (Ni + Cu = 100 wt %) | | (Ni + Cu = 100 wt %) | |
| | So/Sm | Ni(wt %) | Cu(wt %) | Ni(wt %) | Cu(wt %) | Ni(wt %) | Cu(wt %) | Ni(wt %) | Cu(wt %) |
| Example 1 | 83/17 | 0 | 100 | 40 | 60 | 100 | 0 | 100 | 0 |
| Example 31 | 83/17 | 20 | 80 | 43 | 57 | 100 | 0 | 100 | 0 |
| Example 32 | 83/17 | 40 | 60 | 60 | 40 | 100 | 0 | 100 | 0 |
| Example 33 | 83/17 | 60 | 40 | 68 | 32 | 100 | 0 | 100 | 0 |
| Example 41 | 83/17 | 0 | 100 | 38 | 62 | 95 | 5 | 92 | 8 |
| Example 42 | 83/17 | 0 | 100 | 39 | 61 | 85 | 15 | 39 | 61 |
| Example 43 | 83/17 | 0 | 100 | 37 | 63 | 75 | 25 | 37 | 63 |
| Example 44 | 83/17 | 0 | 100 | 40 | 60 | 60 | 40 | 40 | 60 |
| Example 45 | 83/17 | 0 | 100 | 42 | 58 | 50 | 50 | 42 | 58 |

| | | | Temperature | | | |
|---|---|---|---|---|---|---|
| | | | of high | | | 4 points |
| | Metal member | | temperature | Voids in | Voids in | bending |
| | (Ni + Cu = 100 wt %) | | maintaining | cermet | intermediate | strength |
| | Ni(wt %) | Cu(wt %) | step (° C.) | member | layer | (MPa) |
| Example 1 | 70 | 30 | 1200 | None | None | 115 |
| Example 31 | 70 | 30 | 1200 | None | None | 110 |
| Example 32 | 70 | 30 | 1300 | None | None | 61 |
| Example 33 | 70 | 30 | 1350 | None | None | 51 |
| Example 41 | 70 | 30 | 1200 | None | None | 112 |
| Example 42 | 70 | 30 | 1200 | None | None | 110 |
| Example 43 | 70 | 30 | 1200 | None | None | 101 |
| Example 44 | 70 | 30 | 1200 | None | None | 60 |
| Example 45 | 70 | 30 | 1200 | None | None | 52 |

### Examples 51 to 56

The composite bodies of examples 51 to 56 were formed as similar to the example 1 except that the Cu foil having the thickness of 0.2 mm was inserted between the second precursor and the metal member as the third precursor, and the temperature of the high temperature maintaining step was changed.

For the examples 51 to 56 and the example 1, in addition to the evaluations as similar to the above discussed examples, the presence of the void between the first intermediate layer 42 and the metal member was evaluated as well. The mapping of each element by EDS was carried out, and the area between the second intermediate layer 42 and the metal member was determined (in case there is no third intermediate layer 43, and the second intermediate layer 42 and the metal member are bonded, the boundary between the intermediate layer 2 and the metal member was determined). Further, the part where the black contrast appears at area between the second intermediate layer 42 and the metal member from the backscattered electron beam image (BEI) using the electron microscope was determined as the void. In the measurement area of width 1 cm, if the area ratio of this void was 20% or more, then it was defined as present with the void. The results of the example 1 and the examples 51 to 56 are shown in Table 5.

In the examples 51 to 56, by inserting the third precursor between the second precursor and the metal member, the third intermediate layer 43 can be formed. Then, due to the presence of the third intermediate layer 43, the examples 51 to 56 can reduce the void which was present between the second intermediate layer 42 and the metal member compared to the example 1. Note that, in the below Table 5, it shows that the void is present between the second intermediate layer 42 and the metal member for both the example 1 and the example 56; however the area ratio of the void of the example 56 is smaller than the area ratio of void of the example 1.

As for the examples 51 to 56, the third precursor melts by heating as similar to the first precursor. Since the third precursor melts, the second precursor and the metal member can be bonded by the liquid phase diffusion bonding via the third precursor. On the contrary, the example 1 which does not have the third precursor, the second precursor and the metal member will be bonded by the solid phase diffusion bonding. In general, the liquid phase diffusion bonding reduces the void at the boundary compared to the solid phase diffusion bonding, thus it is thought that the examples 51 to 56 has reduced the void between the second intermediate layer 42 and the metal member.

When the examples 52 and 53 having close composition of the first intermediate layer 41 of the example 1 is compared with the example 1, the examples 52 and 53 of which the void between the second intermediate layer 42 and the metal member has reduced also improved the four points bending strength compared to that of the example 1.

TABLE 5

| | | Intermediate member | | | | | |
|---|---|---|---|---|---|---|---|
| | Cermet member | First intermediate layer | | Second intermediate layer | | Third intermediate layer | |
| | (So + Sm = 100) | (Ni + Cu = 100 wt %) | | (Ni + Cu = 100 wt %) | | (Ni + Cu = 100 wt %) | |
| | So/Sm | Ni(wt %) | Cu(wt %) | Ni(wt %) | Cu(wt %) | Ni(wt %) | Cu(wt %) |
| Example 1 | 83/17 | 40 | 60 | 100 | 0 | No third intermediate | |
| | | | | | | layer | |
| Example 51 | 83/17 | 10 | 90 | 100 | 0 | 11 | 89 |
| Example 52 | 83/17 | 25 | 75 | 100 | 0 | 24 | 76 |
| Example 53 | 83/17 | 38 | 62 | 100 | 0 | 39 | 61 |
| Example 54 | 83/17 | 52 | 48 | 100 | 0 | 50 | 50 |
| Example 55 | 83/17 | 60 | 40 | 100 | 0 | 59 | 41 |
| Example 56 | 83/17 | 60 | 40 | 100 | 0 | 73 | 24 |

| | | | | | Voids in area | |
|---|---|---|---|---|---|---|
| | | | | | between | 4 points |
| | Metal member | | Voids in | Voids in | intermediate | bending |
| | (Ni + Cu = 100 wt %) | | cermet | intermediate | layer 2 and metal | strength |
| | Ni(wt %) | Cu(wt %) | member | layer 1 and 2 | member | (MPa) |
| Example 1 | 70 | 30 | None | None | Present | 115 |
| Example 51 | 70 | 30 | None | None | None | 77 |
| Example 52 | 70 | 30 | None | None | None | 118 |
| Example 53 | 70 | 30 | None | None | None | 122 |
| Example 54 | 70 | 30 | None | None | None | 90 |
| Example 55 | 70 | 30 | None | None | None | 72 |
| Example 56 | 70 | 30 | None | None | Present | 60 |

### Examples 61 to 63

The examples 61 to 63 were produced as similar to the example 1 except that the metal member was changed to the member shown in Table 6.

In the examples 61 to 63, regardless of the type of the metal member, a good bonding strength was obtained. Also, the examples 1, 61, and 62 which used the Ni based alloy for the metal member, the bonding strength was improved compared to the example 63 which does not use the Ni based alloy as the metal member.

TABLE 6

| | | | | | | | | | 4 points |
|---|---|---|---|---|---|---|---|---|---|
| | | Intermediate member | | | | | Aperture in | Aperture in | bending |
| | Cermet member | First intermediate layer | | Second intermediate layer | | | cermet | intermediate | strength |
| | So/Sm | Ni(wt %) | Cu(wt %) | Ni(wt %) | Cu(wt %) | Metal member | member | layer | (MPa) |
| Example 61 | 83/17 | 40 | 60 | 100 | 0 | Fe/Cr/Ni = 74/18/8 | None | None | 102 |
| | | | | | | (wt %/wt %/wt %) | | | |
| Example 62 | 83/17 | 40 | 60 | 100 | 0 | Ni/Cr/Fe = 78/16/6 | None | None | 98 |
| | | | | | | (wt %/wt %/wt %) | | | |
| Example 63 | 83/17 | 40 | 60 | 100 | 0 | Fe/C/Cr = | None | None | 51 |
| | | | | | | 86.02/0.08/13.00 | | | |
| | | | | | | (wt %/wt %/wt %) | | | |

Note that, to the metal member and the cermet member used for the above mentioned examples, the expansion ratio was measured using TMA (Thermo-Mechanical Analyzer), and the average linear expansion coefficient was measured at each temperature up till 1400° C. taking 25° C. as the standard temperature.

For the combination of all of the cermet member and the metal member described in the above examples, a difference in absolute value between an average linear expansion coefficient of said cermet member and the average linear expansion coefficient of said metal member being 2.0 ppm/° C. or less was found within a predetermined range of 1000° C. or higher.

As discussed in the above, the assembly body of the cermet member and the metal member according to the present invention can prevent the metal phase in the cermet member from changing into the void by providing the intermediate layer which does not melt by heating, thus the bonding strength improves. Also, the assembly body bonding the metal member and the cermet member via the intermediate member can be used not only or the electrode for molten salt electrolysis but also as the electrode for the aqueous solution electrolysis. Further, by forming the electrode for the electrolysis using the assembly body made of the cermet member and the metal member, the resistivity is lowered and the electric power efficiency can be improved compared to the conventional electrode for the electrolysis.

### REFERENCE SIGNS LIST

1 . . . The assembly body wherein the intermediate member has the two layered structure
2 . . . The assembly body wherein the intermediate member has the three layered structure
10 . . . Oxide phase
12 . . . Spinel ferrite phase
14 . . . Oxide nickel phase
20 . . . Metal phase
30 . . . Cermet member
40 . . . Intermediate member
41 . . . First intermediate layer
42 . . . Second intermediate layer
43 . . . Third intermediate layer
50 . . . Metal member

1. An assembly body comprising a cermet member, a metal member and an intermediate member bonded to said cermet member and said metal member, wherein
said cermet member includes an oxide phase and a metal phase,
said intermediate member comprises at least a first intermediate layer and a second intermediate layer,
said first intermediate layer is bonded to said cermet member,
said first intermediate layer includes at least a first metal M1,
said second intermediate layer includes at least a second metal M2,
a melting point of said first metal M1 is lower than said second metal M2,
a weight concentration of M1 at said first intermediate layer is higher than the weight concentration of M1 at said second intermediate layer, and
the weight concentration of M2 at said second intermediate layer is higher than the weight concentration of M2 at said first intermediate layer.

2. The assembly body as set forth in claim 1 wherein said first intermediate layer is bonded to said second intermediate layer.

3. The assembly body as set forth in claim 1, wherein said second intermediate layer is bonded to said metal member.

4. The assembly body as set forth in claim 1, wherein the weight ratio (M1/M2) between M1 and M2 at said first intermediate layer is within a range of below equation (1).
40/60≦M1/M2≦90/10 Equation (1)

5. The assembly body as set forth in claim 1, wherein M1 is Cu and M2 is Ni.

6. The assembly body as set forth in claim 1, wherein said intermediate member is consisted substantially of Cu and Ni.

7. The assembly body as set forth in claim 1, wherein said intermediate member comprises a third intermediate layer in addition to said first intermediate layer and said second intermediate layer, and
said third intermediate layer is bonded to said metal member.

8. The assembly body as set forth in claim 7, wherein the weight concentration of M1 at said third intermediate layer M1 is higher than the weight concentration of M1 at said second intermediate layer, and
the weight concentration of M2 at said third intermediate layer is lower than the weight concentration of M2 at said second intermediate layer.

9. The assembly body as set forth in claim 7, wherein said second intermediate layer is bonded to said first intermediate layer and said third intermediate layer.

10. The assembly body as set forth in claim 1, wherein said oxide phase included in said cermet member includes at least oxide of Ni.

11. The assembly body as set forth in claim 1, wherein at least part of said oxide phase included in said cermet member is made of nickel ferrite.

12. The assembly body as set forth in claim 1, wherein said metal phase included in said cermet member includes at least one metal selected from Ni, and Cu.

13. The assembly body as set forth in claim 1, wherein Sₒ/Sₘ satisfies below equation (2) when Sₒ is an area of said oxide phase at a cross section of said cermet member, Sₘ is the area of said metal phase and Sₒ/Sₘ is an area ratio between said oxide phase and said metal phase.
60/40≦Sₒ/Sₘ≦90/10 Equation (2)

14. The assembly body as set forth in claim 1, wherein said oxide phase comprises a spinel ferrite phase expressed by a composition formula of NiₓFe_{y}M_{z}O₄ (x+y+z=3, x≠0, y≠0, and M is at least one selected from the group consisting of Al, Co, Cr, Mn, Ti, Zr, Sn, V, Nb, Ta, Hf), and
a nickel oxide phase expressed by the composition formula of Ni_{x′}Fe_{1-x′}O (x′≠0), and
when entire said cermet member including said oxide phase and said metal phase is 100 wt %, then
a content ratio of said spinel ferrite phase is 40 to 80 wt %,
the content ratio of said nickel oxide phase is 0 to 10 wt % (including 0 wt %), and
the content ratio of said metal phase is 15 to 45 wt %.

15. The assembly body as set forth in claim 14, wherein an average composition of said spinel ferrite included in said cermet member is expressed by the composition formula of Niₓ₁Fe_{y1}M_{z1}O₄ (0.60≦x1≦0.90, 1.90≦y1≦2.40, 0.00≦z1≦0.20).

16. The assembly body as set forth in claim 14, wherein said nickel oxide phase is included in said cermet member, and the average composition of said nickel oxide phase is expressed by Ni_{x′1}Fe_{1-x′1}O (0.70≦x′1≦1.00).

17. The assembly body as set forth in claim 1, wherein the content ratio of Ni is 20 to 90 wt %, and the content ratio of Cu is 10 to 80 wt % at said metal phase when entire said metal phase included in said cermet member is 100 wt %.

18. The assembly body as set forth in claim 1, wherein said metal member includes at least one of Ni, Cu, Fe.

19. The assembly body as set forth in claim 18, wherein said metal member includes at least Ni and Fe.

20. The assembly body as set forth in claim 19, wherein a content of Ni included in said metal member is 40 to 85 wt %, and the content of Fe is 15 to 60 wt % when entire said metal member is 100 wt %.

21. The assembly body as set forth in claim 1, wherein a difference in absolute value between an average linear expansion coefficient of said cermet member and the average linear expansion coefficient of said metal member being 2.0 ppm/° C. or less is present within a predetermined range of 1000° C. or higher.

22. The assembly body as set forth in claim 1 used for electrodes for electrolysis.

23. An electrode for an electrolysis comprising the assembly body as set forth in claim 1.

24. A process for producing an assembly body comprising a cermet member, a metal member and an intermediate member having at least a first intermediate layer and a second intermediate layer comprising the steps of
preparing a first precursor to become the first intermediate layer after heating and a second precursor to become the second intermediate layer after heating,
making the first precursor contact with the cermet member and the second precursor arranged between the first precursor and the metal member, and
heating at a temperature where the first precursor melts but the second precursor does not melts in order to bond the cermet member and the metal member.
